(19) United States
(12) Patent Application Publication
(10) Pub. No.: US 2023/0304896 A1
(43) Pub. Date: Sep. 28, 2023

(54) METHOD FOR EVALUATING PERFORMANCE OF SELF-DRIVING VEHICLE ORIENTED TO FULL PARAMETER SPACE OF LOGICAL SCENARIO

(71) Applicant: JILIN UNIVERSITY, Changchun (CN)

(72) Inventors: BING ZHU, Changchun (CN); Peixing Zhang, Changchun (CN); Jian Zhao, Changchun (CN); Tianxin Fan, Changchun (CN); Yuhang Sun, Changchun (CN)

(21) Appl. No.: 17/943,167

(22) Filed: Sep. 12, 2022

(30) Foreign Application Priority Data
Mar. 22, 2022 (CN) 202210285067.9
Mar. 22, 2022 (CN) 202210285074.9

(51) Int. Cl. G01M 17/00; B60W 30/095

(52) U.S. Cl. CPC G01M 17/00; B60W 30/095; B60W 2554/80

(57) ABSTRACT

A method for evaluating performance of a self-driving vehicle oriented to full parameter space of a logical scenario is provided. After the test logic scenario of the self-driving vehicle system and its matched parameter space are given, the tested self-driving vehicle system is put into the logic scenario for testing, and the driving data under each specific test condition is obtained. After the driving trajectory of the tested self-driving vehicle system in the whole test logic scenario parameter space is obtained, the logic scenario is divided into two parts according to the ideal vehicle motion curve, namely, a safe region and a dangerous region. The key points and indicators of evaluation in the two regions are determined.

This patent application claims the benefit and priorities of Chinese Patent Application No. 202210285067.9 filed on Mar. 22, 2022, and No. 202210285074.9, filed on Mar. 22, 2022, the disclosure of which is incorporated by reference herein in its entirety as part of the present application.

### TECHNICAL FIELD

The disclosure relates to the technical field of self-driving vehicle testing and evaluating, and more specifically, to a method for evaluating performance of a self-driving vehicle oriented to full parameter space of a logical scenario.

### BACKGROUND ART

The disclosure provides a method for evaluating the performance of a self-driving vehicle oriented to a full parameter space of a logical scenario, after the test logic scenario of the tested self-driving vehicle system and its matched parameter space are given, the tested self-driving vehicle system is put into the logic scenario for testing, and the driving data under each specific test condition is obtained. After obtaining the driving trajectory of the tested self-driving vehicle system in the whole parameter space of the tested logic scenario, the logic scenario is divided into two parts: a safe region and a dangerous region according to the ideal vehicle motion curve. Then, the key points and indicators of evaluation in the two regions are determined. According to the test results, the overall performance in the whole parameter space is calculated, so as to obtain the performance evaluation results of the whole parameter space.

In conjunction with the drawings, technical schemes of the disclosure are described as follows.

A method for evaluating the performance of a self-driving vehicle oriented to a full parameter space of a logical scenario, including the following steps is disclosed.

In step 1, logical scenario parameter space is divided.

In step 2, evaluation dimensions in different regions of the logical scenario parameter space are determined.

In step 3, a traveling trajectory is calculated.

In step 4, a human-like nature evaluation index in a safe region is constructed.

In step 5, an evaluation index of collision avoidance in a dangerous region is constructed.

In step 6, full-parameter spatial evaluation indicators for the logical scenario are built.

Specifically, the method of the step 1 further includes as follows.

The logical scenario parameter space is divided into a dangerous region and a safe region in accordance with the natural drive data of the human driver or the dangerous situation in the drive process of the preset qualified system. The dangerous region is defined as an area where a collision may occur while driving. The safe region is defined as an area which is safe when driving and is difficult to collide.

wherein, the principle of zoning is whether the danger can be avoided if the vehicle only decelerates; the maximum braking deceleration is set to 5 m/s², during driving, vehicles equipped with qualified systems or human drivers can timely and accurately perceive all kinds of information of obstacles ahead, the information includes type, speed and position, when the vehicle travels to the dangerous distance set by the safe distance model, the vehicle immediately decelerates, and records the information of ITTC, the reciprocal of collision time of the vehicle equipped with the qualified system in the whole driving scenario. The calculation formula of the reciprocal of collision time is shown in formula (1). If the maximum value of ITTC in the whole mileage is not more than 0.7 s⁻¹, the scenario is considered as a safe scenario. Otherwise, the scenario is considered as a dangerous scenario.

ITTC=V/d (1)

wherein, d is the relative distance between the measured vehicle and the obstacle; V is the relative speed between the measured vehicle and the obstacle.

because all parameter combinations in the parameter space can't be tested, it's impossible to obtain the accurate continuous boundary between the danger zone and the safe region by testing; Gaussian process is used to fit the boundary; Gaussian process is shown in formula (2):

f(x)˜GP(m,k) (2)

wherein, f(x) is the fitting result; m is the mean function; k is the covariance function; m is defined as 0 matrix, and the kernel density function is square exponential kernel function, as shown in formula (3):

$$k ( x , {x}^{⋆} ) = {σ}_{f}^{2} exp [ - \frac{1}{2} \cdot \frac{{( x - {x}^{⋆} )}^{T} ( x - {x}^{⋆} )}{{σ}_{l}^{2}} ] \qquad ( 3 )$$

wherein, σ_{f} is the scalar of characteristic length; σ is the standard deviation of the signal; x is training data; x* is the data at an unknown location;

after Gaussian process fitting, the dangerous region and the safe region in the parameter space are finally divided, so as to obtain the dangerous region and the safe region.

The specific method of the step 2 is as follows:

the evaluation dimension in the danger zone is reflected by the collision avoidance index; the evaluation dimension in the security zone is embodied by the anthropomorphic index.

4. the specific method of the step 3 is as follows:

the running trajectory refers to the track left by the influence on the surrounding space during the running of the vehicle, and is related to the running track of the vehicle, the corresponding position speed, the corresponding position influence time, and the physical parameters of the vehicle, Since the quasi-human evaluation is aimed at the same vehicle, the influence of the physical parameters of the vehicle is removed; the defined trajectory field is shown in formula (4), when the vehicle stops moving after operation, the average time of passing through the scenario is selected as the calculation time; the calculation of the surrounding space impact at a specific time point is shown in formula (5);

$$S = \sum s \qquad ( 4 )$$

$$s = \frac{{r}_{ij}}{{\vert {r}_{ij} \vert}^{{k}_{1}} \vert {r}_{ij} \vert} exp [ {k}_{2} {v}_{i} cos ( {θ}_{i} ) ] \qquad ( 5 )$$

In the above formula, S is the trajectory, or namely, the sum of the influence of the whole drive process of the vehicle on the surrounding space. s is the instantaneous field, that is, the impact of the moment the vehicle travels on the surrounding time and space; rᵢⱼ, is a vector composed of different positions and vehicle centers; vᵢ is the speed of the vehicle; θi is the angle between rᵢⱼ and vi; k₁ and k₂ are correction parameters.

the vehicle is regarded as a particle, and the instantaneous field value which is 1 m away from the center of mass of the vehicle is regarded as the instantaneous field value within 1 m of the whole vehicle.

The specific method of step 4 is as follows:

due to the difference of the driving data of different drivers, there are differences in the driving trajectory in the corresponding scenario calculated according to the driving data of different real drivers, and Gaussian distribution is used to describe the actual driving trajectory field values at different positions in the whole scenario, that is, the driving trajectory field values at different positions are all described using Gaussian distribution, as shown in formula (6);

$$f ( v ) = \frac{1}{\sqrt{2 π} σ} exp ( - \frac{{( h - μ )}^{2}}{2 {σ}^{2}} ) \qquad ( 6 )$$

in the formula, h is the specific value of the running locus field at different positions in the coordinate system; μ and σ are the mean and standard deviation of the values of the locus field at the corresponding positions.

The human-like nature index includes four parts, which are part one: operation number correction factor; part two: the mileage correction increasing factor; part three: similarity of driving tracks; part four: similarity of driving speed in corresponding position; according to the four indexes, the anthropomorphic index is set up as shown in formula (7), and the maximum value of anthropomorphic index is 1;

$${D}_{i} = \frac{1}{{n}_{m}} \cdot \frac{{k}_{3} \cdot L}{{L}_{m e a n}} \cdot \frac{{k}_{4} \cdot {n}_{h}}{{n}_{A}} \cdot {\sum }_{r = 0}^{min ( L , {L}_{mean} )} ( min ( 1 , \frac{{p}_{t \_ r}}{{p}_{t \_ 2 σ\_ r}} ) \cdot {\sum }_{j = 1}^{n} min ( 1 , \frac{{p}_{v \_ j}}{{p}_{v \_ 2 σ\_ j}} ) ) \qquad ( 7 )$$

In the formula, L is the travel distance of the self-driving vehicle system under test in a specific scenario, and L is the distance between the starting point and the ending point along the road direction when the vehicle under the self-driving vehicle system under test stops, if no parking occurs, the length of the scenario along the road.

Lₘₑₐₙ is the average driving distance of real human drivers in the corresponding scenarios, and the driving distance of each real human driver is obtained in the same way as L; nₕ is the number of times the tested self-driving vehicle system operates the vehicle, it is stipulated that when the absolute value of braking or acceleration is greater than 0.5 m/s², the brake pedal or accelerator pedal returns to the initial position as a vehicle operation, and when the steering wheel angle of the vehicle is greater than 10 degrees, it returns to the initial position from the reverse direction as a vehicle operation; n_{A} is the average operation times of real drivers, and the operation times of a single real driver are obtained in the same way as nₕ; r is the road sampling position, defining the length along the road between each sampling is 0.5 m, and the sampling position is a line segment, that is, a line segment with the boundary of the lane in the coordinate system when x=r; when the distance between the penultimate sampling position and the road end point is less than 0.5 m, the road end point position of the segment is directly sampled without considering the interval of 0.5 m; P_{t_r} is the Gaussian distribution formed by the vehicle position of the real driver on the sampling line segment, and the probability of the value of the vehicle position of the tested self-driving vehicle system in this Gaussian distribution, the description of the probability distribution of the real driver belonging to different Y values at the sampling position is shown in formula (6); wherein h becomes the value of the vehicle position of different real drivers on the Y axis at the sampling position; μ and σ become the mean and standard deviation of the corresponding Y value; P_{t_2σ_r} is the probability that the vehicle position belongs to the mean of the true driver's Y axis position plus twice the standard deviation; P_{v_j} is the probability that the running locus field at different sampling points on the sampling line segment is the specific value when the real driver is driving, and is calculated using formula (6).

P_{v_2σ_j} is the driving trajectory of the real driver at different sampling points on the sampling line, which is the corresponding probability at the position of the average value at the sampling point plus twice the standard deviation at the sampling point; nₛ is the number of sampling points on a sampling line segment, with a specific value of 9; nm is the number of all sampling points; k₃ and k₄ are correction coefficients, when the measured self-driving vehicle system operation times are less than the real driver and the driving range is longer than the real driver, the maximum value of D is corrected to 1 by using k₃ and k₄, and modify the results of other tested self-driving vehicle systems that have participated in the test evaluation, otherwise k₃, k₄ directly take 1.

The road data forwarded with an interval of 0.5 m in the road direction is sampled until the end of the road.

when selecting a sampling point in a sampling line segment, take the vehicle position as the center, sample 4 points up and down at a step of 0.5 m, and sample 9 points in the whole slice. When the distance between the vehicle position and the road boundary on a sampling line segment is less than 2 m, divide the length between the vehicle position and the road boundary into four equal parts, and sample data at these four equal parts, regardless of the interval of 0.5 m;

according to the sampled data, the similarity between the tested self-driving vehicle system and the real driver is calculated by the formula (7) and the human-like evaluation result is obtained.

Under real natural driving conditions, the higher the probability of occurrence of a scenario, the longer the driver experiences the scenario and the greater the proportion of the scenario. Therefore, after obtaining the human-like evaluation index of a single specific scenario, the evaluation result within the whole safety area is obtained with the weight of probability, as shown in formula (8),

$$D = {{\sum }_{i = 1}}^{n} \frac{{p}_{i} \cdot {D}_{i}}{{{\sum }_{i = 1}}^{n} {p}_{i}} \qquad ( 8 )$$

In the formula, pᵢ is the probability of occurrence of the ith specific scenario in this type of scenario under natural driving conditions.

The specific method of the step 5 is as follows:

in the evaluation of collision avoidance performance in a dangerous region, two parts are included, one part is whether the danger can be avoided, the other part is whether the collision loss can be reduced when the danger is unavoidable;

$${L}_{i} = \{ \begin{matrix}1 , 15 < {U}_{i} \\ 0.7 , 8 < {U}_{i} \leq 15 \\ 0.4 , 0 < {U}_{i} \leq 8 \\ 0.1 , others\end{matrix} \qquad ( 9 )$$

$${U}_{i} = \frac{1}{w} \cdot ‖ {v}_{e} - {v}_{o} ‖ \qquad ( 10 )$$

wherein Li is the collision loss of the measured method in the ith specific scenario; w is the bumper utilization rate of the measured vehicle during collision, that is, the area of the bumper involved in the collision, and the minimum is 0.5; vₑ and vₒ are the speed of the vehicle under test and the speed of the obstacle under test; Uᵢ is the severity of the collision.

In addition to that loss of collision, the importance weights of the scenario at different locations are different; for a collision, once a collision occurs, it is a defined event for the occupant, Therefore, the avoidance ability of collision is considered in the danger area, rather than the relative probability of occurrence of the relevant scenario;

when evaluating the collision avoidance capability, the relative distance between the current specific scenario parameter position and the most dangerous parameter position is taken into consideration, and the calculation method of the distance is shown in the formula (11),

$${r}_{i} = \frac{‖ {r}_{i}^{*} ‖}{‖ {r}_{i}^{**} ‖} \qquad ( 11 )$$

Where rᵢ is the relative weight of the ith specific scenario in the danger zone; rᵢ* is the vector formed by the most dangerous parameter points in the logical scenario parameter space and the specific scenario parameter points; rᵢ** is the vector formed by the intersection of the most dangerous parameter point in the parameter space of the logical scenario and the straight line where rᵢ* is located and the boundary of the safe region/dangerous region;

After the collision loss and the corresponding weight of the measured method in the specific scenario are obtained, the evaluation index of the whole danger zone is obtained. Because the ideal algorithm assumes that its perception system, decision-making system and execution system are all running in an ideal state, its collision loss must be the smallest, so the value of c must be less than or equal to 1.

$$C = \frac{{\sum }_{i = 1}^{{n}_{c}} {r}_{i} \cdot \frac{{L}_{gi}}{{L}_{i}}}{{\sum }_{i = 1}^{{n}_{c}} {r}_{i}} \qquad ( 12 )$$

Wherein, C is the safety index; L_{gi} is the collision loss of the ideal system in the ith specific scenario in the danger zone; n_{c} is the number of specific scenarios where all collisions occur.

The specific method of step 6 is as follows:

after obtaining the evaluation index in the safe region and the evaluation index in the dangerous region, combining the two to obtain the performance evaluation of the measured method in the entire logical scenario parameter space; based on the percentage system, the comprehensive evaluation index result of the measured method is

S=a·k₅·C+b·k₆·D (13)

In the formula, a and b are the relative scores of the safety index and the smoothness index, and the sum of the two is 100 in the case of the percentile system; k₅ and k₆ are the correction parameters, and when the number of tested systems is lower than the threshold, The threshold value is taken as 10, and the two may be taken as 1 respectively. when the tested system exceeds the threshold value, the values of the two are corrected according to the statistical results, so that the evaluation results of different test systems have the statistical characteristics of Gaussian distribution or exponential distribution.

The disclosure has the beneficial effects that:

According to the method, the logical scenario parameter space is divided according to the risk degrees of different specific scenarios, and the evaluation dimensions and specific evaluation indexes in the two regions are determined, so that the overall performance in the whole logical scenario parameter space can be obtained according to the test results of the measured method. Finally, the self-driving vehicle performance evaluation at the logical scenario level can be obtained, and the evaluation can be targeted according to the evaluation emphasis at different specific scenario positions.

### BRIEF DESCRIPTION OF THE DRAWINGS

In order to explain the technical scheme of the embodiments of the present disclosure more clearly, the following drawings that need to be used in the embodiments will be briefly introduced. It should be understood that the following drawings only show some embodiments of the present disclosure, so they should not be regarded as limiting the scope. For those skilled in the art, other relevant drawings can be obtained according to these drawings without any creative efforts.

FIG. 1 is a flow chart of the disclosure.

FIG. 2 is a schematic structural diagram of an embodiment of the present disclosure.

### DETAILED DESCRIPTION OF THE EMBODIMENTS

The technical solutions in the embodiments of the present disclosure will be clearly and completely described below with reference to the drawings in the embodiments of the present disclosure. Obviously, the described embodiments are only part of the embodiments of the present disclosure, but not all of them. Based on the embodiment of the present disclosure, all other embodiments obtained by ordinary technicians in the field without creative labor are within the scope of the present disclosure.

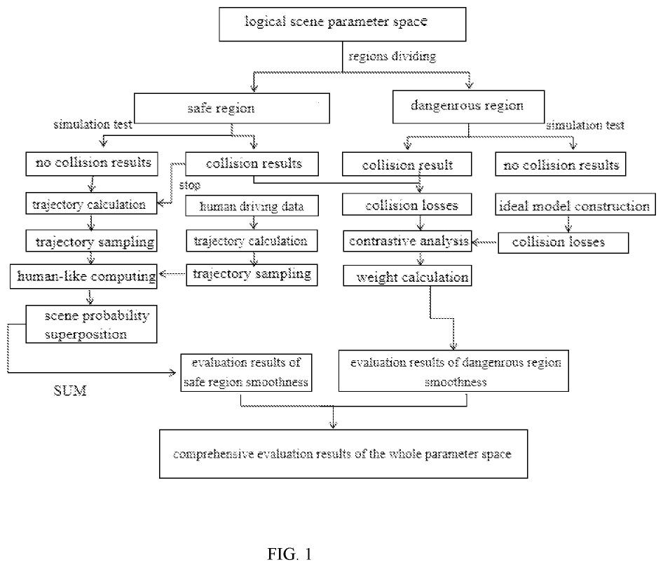

Referring to FIG. 1, a method for evaluating the performance of a self-driving vehicle oriented to a full parameter space of a logical scenario, including the following steps are disclosed.

step 1: dividing a logical scenario parameter space;

in accordance with the natural drive data of the human driver or the dangerous situation in the drive process of the preset qualified system, the logical scenario parameter space is divided into a dangerous region and a safe region; the dangerous region refers to an area where a collision may occur while driving; the safe region refers to an area which is safe when driving and is difficult to collide;

wherein, the principle of zoning is whether the danger can be avoided if the vehicle only decelerates; the maximum braking deceleration is set to 5 m/s², during driving, vehicles equipped with qualified systems or human drivers can timely and accurately perceive all kinds of information of obstacles ahead, the information includes type, speed and position, when the vehicle travels to the dangerous distance set by the safe distance model, the vehicle immediately decelerates, and records the information of ITTC, the reciprocal of collision time of the vehicle equipped with the qualified system in the whole driving scenario, the calculation formula of the reciprocal of collision time is shown in formula (1); if the maximum value of ITTC in the whole mileage is not more than 0.7 s⁻¹, the scenario is considered as a safe scenario; otherwise, the scenario is considered as a dangerous scenario;

ITTC=V/d (1)

wherein, d is the relative distance between the measured vehicle and the obstacle; V is the relative speed between the measured vehicle and the obstacle; because all parameter combinations in the parameter space can't be tested, it's impossible to obtain the accurate continuous boundary between the danger zone and the safe region by testing; Gaussian process is used to fit the boundary; Gaussian process is shown in formula (2):

f(x)˜GP(m,k) (2)

wherein, f(x) is the fitting result; M is the mean function; K is the covariance function; M is defined as 0 matrix, and the kernel density function is square exponential kernel function, as shown in formula (3):

$$k ( x , {x}^{⋆} ) = {σ}_{f}^{2} exp [ - \frac{1}{2} \cdot \frac{{( x - {x}^{⋆} )}^{T} ( x - {x}^{⋆} )}{{σ}_{l}^{2}} ] \qquad ( 3 )$$

wherein, σ_{f} is the scalar of characteristic length; σ is the standard deviation of the signal; X is training data; X* is the data at an unknown location;

after Gaussian process fitting, the dangerous region and the safe region in the parameter space are finally divided, so as to obtain the dangerous region and the safe region.

step 2: determining evaluation dimensions in different regions of the logical scenario parameter space;

the evaluation dimension in the danger zone is reflected by the collision avoidance index; the evaluation dimension in the security zone is embodied by the anthropomorphic index.

Specifically, the running trajectory refers to the track left by the influence on the surrounding space during the running of the vehicle, and is related to the running track of the vehicle, the corresponding position speed, the corresponding position influence time, and the physical parameters of the vehicle, Since the quasi-human evaluation is aimed at the same vehicle, the influence of the physical parameters of the vehicle is removed; the defined trajectory field is shown in formula (4), when the vehicle stops moving after operation, the average time of passing through the scenario is selected as the calculation time; the calculation of the surrounding space impact at a specific time point is shown in formula (5);

$$S = \sum s \qquad ( 4 )$$

$$s = \frac{{r}_{ij}}{{\vert {r}_{ij} \vert}^{{k}_{1}} \vert {r}_{ij} \vert} exp [ {k}_{2} {v}_{i} cos ( {θ}_{i} ) ] \qquad ( 5 )$$

in the formula, S is the trajectory, that is, the sum of the influence of the whole drive process of the vehicle on the surrounding space; s is the instantaneous field, that is, the impact of the moment the vehicle travels on the surrounding time and space; rᵢⱼ is a vector composed of different positions and vehicle centers; Vᵢ is the speed of the vehicle; θᵢ is the angle between rᵢⱼ and vᵢ; k₁ and k₂ are correction parameters; the vehicle is regarded as a particle, and the instantaneous field value which is 1 m away from the center of mass of the vehicle is regarded as the instantaneous field value within 1 m of the whole vehicle.

Step 4: constructing a human-like nature evaluation index in a safe region;

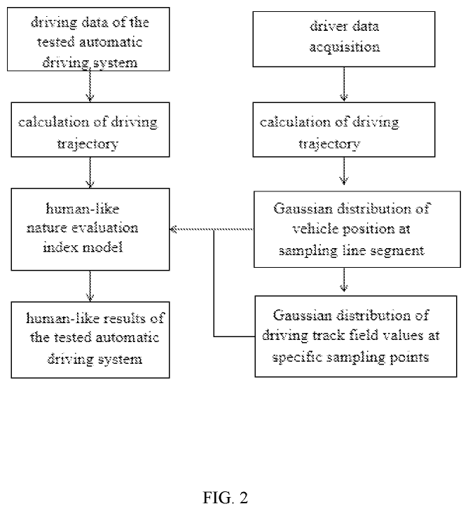

Referring to FIG. 2, the anthropomorphic calculation is performed as follows:

due to the difference of the driving data of different drivers, there are differences in the driving trajectory in the corresponding scenario calculated according to the driving data of different real drivers, and Gaussian distribution is used to describe the actual driving trajectory field values at different positions in the whole scenario, that is, the driving trajectory field values at different positions are all described using Gaussian distribution, as shown in formula (6);

$$f ( v ) = \frac{1}{\sqrt{2 π} σ} exp ( - \frac{{( h - μ )}^{2}}{2 {σ}^{2}} ) \qquad ( 6 )$$

in the formula, h is the specific value of the running locus field at different positions in the coordinate system; μ and σ are the mean and standard deviation of the values of the locus field at the corresponding positions.

The human-like nature index includes four parts, which are part one: operation number correction factor; part two: the mileage correction increasing factor; part three: similarity of driving tracks; part four: similarity of driving speed in corresponding position; according to the four indexes, the anthropomorphic index is set up as shown in formula (7), and the maximum value of anthropomorphic index is 1;

$${D}_{i} = \frac{1}{{n}_{m}} \cdot \frac{{k}_{3} \cdot L}{{L}_{mean}} \cdot \frac{{k}_{4} \cdot {n}_{h}}{{n}_{A}} \cdot {\sum }_{r = 0}^{min ( L , {L}_{mean} )} ( min ( 1 , \frac{{p}_{t \_ r}}{{p}_{t \_ 2 σ \_ r}} ) \cdot {\sum }_{j = 1}^{{n}_{s}} min ( 1 , \frac{{p}_{v \_ j}}{{p}_{v \_ 2 σ \_ j}} ) ) \qquad ( 7 )$$

in the formula, L is the travel distance of the self-driving vehicle system under test in a specific scenario, and L is the distance between the starting point and the ending point along the road direction when the vehicle under the self-driving vehicle system under test stops, if no parking occurs, the length of the scenario along the road; Lₘₑₐₙ is the average driving distance of real human drivers in the corresponding scenarios, and the driving distance of each real human driver is obtained in the same way as L; Nₕ is the number of times the tested self-driving vehicle system operates the vehicle, it is stipulated that when the absolute value of braking or acceleration is greater than 0.5 m/s², the brake pedal or accelerator pedal returns to the initial position as a vehicle operation, and when the steering wheel angle of the vehicle is greater than 10 degrees, it returns to the initial position from the reverse direction as a vehicle operation; n_{A} is the average operation times of real drivers, and the operation times of a single real driver are obtained in the same way as nₕ; r is the road sampling position, defining the length along the road between each sampling is 0.5 m, and the sampling position is a line segment, that is, a line segment with the boundary of the lane in the coordinate system when x=r; when the distance between the penultimate sampling position and the road end point is less than 0.5 m, the road end point position of the segment is directly sampled without considering the interval of 0.5 m; Pt_r is the Gaussian distribution formed by the vehicle position of the real driver on the sampling line segment, and the probability of the value of the vehicle position of the tested self-driving vehicle system in this Gaussian distribution, the description of the probability distribution of the real driver belonging to different Y values at the sampling position is shown in formula (6); wherein h becomes the value of the vehicle position of different real drivers on the Y axis at the sampling position; μ and σ become the mean and standard deviation of the corresponding Y value; P_{t_2σ_r} is the probability that the vehicle position belongs to the mean of the true driver's Y axis position plus twice the standard deviation; P_{v_j} is the probability that the running locus field at different sampling points on the sampling line segment is the specific value when the real driver is driving, and is calculated using formula (6); P_{v_2σ_i} is the driving trajectory of the real driver at different sampling points on the sampling line, which is the corresponding probability at the position of the average value at the sampling point plus twice the standard deviation at the sampling point; nₛ is the number of sampling points on a sampling line segment, with a specific value of 9; nₘ is the number of all sampling points; k₃ and k₄ are correction coefficients, when the measured self-driving vehicle system operation times are less than the real driver and the driving range is longer than the real driver, the maximum value of D is corrected to 1 by using k₃ and k₄, and modify the results of other tested self-driving vehicle systems that have participated in the test evaluation, otherwise k₃, k₄ directly take 1. Sampling the road data forward at intervals of 0.5 m in the road direction until the end of the road; when selecting a sampling point in a sampling line segment, take the vehicle position as the center, sample 4 points up and down at a step of 0.5 m, and sample 9 points in the whole slice. When the distance between the vehicle position and the road boundary on a sampling line segment is less than 2 m, divide the length between the vehicle position and the road boundary into four equal parts, and sample data at these four equal parts, regardless of the interval of 0.5 m; according to the sampled data, the similarity between the tested self-driving vehicle system and the real driver is calculated by the formula (7) and the human-like evaluation result is obtained.

Under real natural driving conditions, the higher the probability of occurrence of a scenario, the longer the driver experiences the scenario and the greater the proportion of the scenario. Therefore, after obtaining the human-like evaluation index of a single specific scenario, the evaluation result within the whole safety area is obtained with the weight of probability, as shown in formula (8),

$$D = {\sum }_{i = 1}^{n} \frac{{p}_{i} \cdot {D}_{i}}{{\sum }_{i = 1}^{n} {p}_{i}} \qquad ( 8 )$$

in the formula, pᵢ is the probability of occurrence of the ith specific scenario in this type of scenario under natural driving conditions.

Step 5: construct the evaluation index of collision avoidance in the dangerous region;

the specific method of the step 5 is as follows:

in the evaluation of collision avoidance performance in a dangerous region, two parts are included, one part is whether the danger can be avoided, the other part is whether the collision loss can be reduced when the danger is unavoidable;

$${L}_{i} = \{ \begin{matrix}1 , & 15 < {U}_{i} \\ 0.7 , & 8 < {U}_{i} \leq 15 \\ 0.4 , & 0 < {U}_{i} \leq 8 \\ 0.1 , & others\end{matrix} \qquad ( 9 )$$

$${U}_{i} = \frac{1}{w} \cdot ‖ {v}_{e} - {v}_{o} ‖ \qquad ( 10 )$$

wherein Li is the collision loss of the measured method in the ith specific scenario; w is the bumper utilization rate of the measured vehicle during collision, that is, the area of the bumper involved in the collision, and the minimum is 0.5; Ve and vₒ are the speed of the vehicle under test and the speed of the obstacle under test; U_i is the severity of the collision.

In addition to the collision loss, the importance weights of scenarios in different positions are also different; as for the collision, once it happens, it is a definite event for the passengers, so the avoidance ability of the collision should be considered in the danger zone, rather than the relative probability of the relevant scenario;

when evaluating the collision avoidance ability, consider the relative distance between the current specific scenario parameter position and the most dangerous parameter position, and the calculation method of the distance is shown in formula (11):

$${r}_{i} = \frac{‖ {r}_{i}^{*} ‖}{‖ {r}_{i}^{**} ‖} \qquad ( 11 )$$

Wherein, rᵢ is the relative weight of the ith specific scenario in the danger zone; rᵢ* is the vector formed by the most dangerous parameter points in the logical scenario parameter space and the specific scenario parameter points; rᵢ** is the vector formed by the intersection of the most dangerous parameter point in the parameter space of the logical scenario and the straight line where rᵢ* is located and the boundary of the safe region/dangerous region; after the collision loss and the corresponding weight of the measured method in the specific scenario are obtained, the evaluation index of the whole danger zone is obtained; because the ideal algorithm assumes that its perception system, decision-making system and execution system are all running in an ideal state, its collision loss must be the smallest, so the value of c must be less than or equal to 1.

$$C = \frac{{\sum }_{i = 1}^{{n}_{c}} {r}_{i} \cdot \frac{{L}_{gi}}{{L}_{i}}}{{\sum }_{i = 1}^{{n}_{c}} {r}_{i}} , \qquad ( 12 )$$

In the formula, C is the safety index, L gi is the collision loss of the ideal system in the i-th specific scenario in the dangerous region, and n c is the number of specific scenarios where all collisions occur.

Step 6: Construct the evaluation index of the full parameter space of the logic scenario.

The specific method is as follows:

after obtaining the evaluation index in the safe region and the evaluation index in the dangerous region, the performance evaluation of the measured method in the whole logic scenario parameter space is obtained by combining them; based on the percentage system, the comprehensive evaluation index result of the measured method is as follows:

S′=a·k₅·C+b·k₆·D (13)

Wherein, a and b are the relative scores of safety index and smoothness index, and the sum of them is 100 in the case of 100-point system; k₅ and k₆ are correction parameters when the number of systems under test is below a threshold, The threshold value is 10, and the two values can be 1 respectively, when the system under test exceeds the threshold value, the values of the two values are modified according to the statistical results, so that the evaluation results of different test systems have the statistical characteristics of Gaussian distribution or exponential distribution.

The preferred embodiments of the present disclosure have been described in detail with reference to the drawings above, but the scope of protection of the present disclosure is not limited to the specific details of the above embodiments. Within the technical concept of the present disclosure, any person familiar with the technical field can make equivalent substitutions or changes according to the technical scheme and the inventive concept of the present disclosure, and these simple modifications all belong to the scope of protection of the present disclosure.

In addition, it should be noted that the specific technical features described in the above specific embodiments can be combined in any suitable way without contradiction. In order to avoid unnecessary repetition, the present disclosure will not separately explain various possible combinations.

In addition, any combination of different embodiments of the present disclosure can also be made, as long as it does not violate the idea of the present disclosure, it should also be regarded as the disclosed content of the present disclosure.

What is claimed is:

1. A method for evaluating performances of a self-driving vehicle oriented to a full parameter space of a logical scenario, comprising:
S1: dividing a logical scenario parameter space;
S2: determining evaluation dimensions in different regions of the logical scenario parameter space;
S3: calculating a traveling trajectory;
S4: constructing a human-like nature evaluation index in a safe region;
S5: constructing an evaluation index of collision avoidance in a dangerous region; and
S6: building full-parameter spatial evaluation indicators for the logical scenario.

2. The method of claim 1, wherein the S1 further comprises:
dividing the logical scenario parameter space into a dangerous region and a safe region in accordance with the natural drive data of the human driver or the dangerous situation in the drive process of the preset qualified system;
wherein the dangerous region is defined as an area where a collision may occur while driving; and the safe region is defined as an area which is safe when driving and is difficult to collide;
the principle of zoning is whether the danger can be avoided if the vehicle only decelerates; the maximum braking deceleration is set to 5 m/s², during driving, vehicles equipped with qualified systems or human drivers can timely and accurately perceive all kinds of information of obstacles ahead, the information comprises type, speed and position, when the vehicle travels to the dangerous distance set by the safe distance model, the vehicle immediately decelerates, and records the information of ITTC, the reciprocal of collision time of the vehicle equipped with the qualified system in the whole driving scenario, the calculation formula of the reciprocal of collision time is shown in formula (1);
if the maximum value of ITTC in the whole mileage is not more than 0.7 s⁻¹, the scenario is determined as a safe scenario; otherwise, the scenario is determined as a dangerous scenario;
ITTC=v/d (1)
wherein, d is the relative distance between the measured vehicle and the obstacle; V is the relative speed between the measured vehicle and the obstacle;
Gaussian process is used to fit the boundary; Gaussian process is shown in formula (2):
f(x)˜GP(m,k) (2)
wherein, f(x) is the fitting result; M is the mean function; K is the covariance function; M is defined as 0 matrix, and the kernel density function is square exponential kernel function, as shown in formula (3):
$$k ( x , {x}^{*} ) = {σ}_{f}^{2} exp [ - \frac{1}{2} \cdot \frac{{( x - {x}^{*} )}^{T} ( x - {x}^{*} )}{{σ}_{l}^{2}} ] \qquad ( 3 )$$
wherein, σ_{f} is the scalar of characteristic length; σ is the standard deviation of the signal; X is training data; X* is the data at an unknown location;
after Gaussian process fitting, the dangerous region and the safe region in the parameter space are finally divided, so as to obtain the dangerous region and the safe region.

3. The method of claim 1, wherein the S2 further comprises:
the evaluation dimension in the danger zone is reflected by the collision avoidance index; the evaluation dimension in the security zone is embodied by the anthropomorphic index.

4. The method of claim 1, wherein the S3 further comprises:
the running trajectory refers to the track left by the influence on the surrounding space during the running of the vehicle, and is related to the running track of the vehicle, the corresponding position speed, the corresponding position influence time, and the physical parameters of the vehicle, since the quasi-human evaluation is aimed at the same vehicle, the influence of the physical parameters of the vehicle is removed; the defined trajectory field is shown in formula (4), when the vehicle stops moving after operation, the average time of passing through the scenario is selected as the calculation time; the calculation of the surrounding space impact at a specific time point is shown in formula (5);
$$S = \sum s \qquad ( 4 )$$
$$s = \frac{{r}_{ij}}{{\vert {r}_{ij} \vert}^{{k}_{1}} \vert {r}_{ij} \vert} exp [ {k}_{2} {v}_{i} cos ( {θ}_{i} ) ] \qquad ( 5 )$$
in the formula, S is the trajectory, that is, the sum of the influence of the whole drive process of the vehicle on the surrounding space; s is the instantaneous field, that is, the impact of the moment the vehicle travels on the surrounding time and space; rᵢⱼ is a vector composed of different positions and vehicle centers; vᵢ is the speed of the vehicle; θᵢ is the angle between rᵢⱼ and vᵢ; k₁ and k₂ are correction parameters;
the vehicle is regarded as a particle, and the instantaneous field value which is 1 m away from the center of mass of the vehicle is regarded as the instantaneous field value within 1 m of the whole vehicle.

5. The method of claim 1, wherein the S4 further comprises:
due to the difference of the driving data of different drivers, there are differences in the driving trajectory in the corresponding scenario calculated according to the driving data of different real drivers, and Gaussian distribution is used to describe the actual driving trajectory field values at different positions in the whole scenario, that is, the driving trajectory field values at different positions are all described using Gaussian distribution, as shown in formula (6);
$$f ( v ) = \frac{1}{\sqrt{2 π} σ} exp ( - \frac{{( h - μ )}^{2}}{2 {σ}^{2}} ) \qquad ( 6 )$$
in the formula, h is the specific value of the running locus field at different positions in the coordinate system; μ and σ are the mean and standard deviation of the values of the locus field at the corresponding positions;
the human-like nature index comprises four parts, which are part one: operation number correction factor; part two: the mileage correction increasing factor; part three: the similarity of driving tracks; part four: similarity of driving speed in corresponding position; according to the four indexes, the anthropomorphic index is set up as shown in formula (7), and the maximum value of anthropomorphic index is 1;
$${D}_{i} = \frac{1}{{n}_{m}} \cdot \frac{{k}_{3} \cdot L}{{L}_{mean}} \cdot \frac{{k}_{4} \cdot {n}_{h}}{{n}_{A}} \cdot {\sum }_{r = 0}^{min ( L , {L}_{mean} )} ( min ( 1 , \frac{{p}_{t \_ r}}{{p}_{t \_ 2 σ \_ r}} ) \cdot {\sum }_{j = 1}^{{n}_{s}} min ( 1 , \frac{{p}_{v \_ j}}{{p}_{v \_ 2 σ \_ j}} ) ) \qquad ( 7 )$$
in the formula, L is the travel distance of the self-driving vehicle system under test in a specific scenario, and L is the distance between the starting point and the ending point along the road direction when the vehicle under the self-driving vehicle system under test stops, if no parking occurs, the length of the scenario along the road;
Lₘₑₐₙ is the average driving distance of real human drivers in the corresponding scenarios, and the driving distance of each real human driver is obtained in the same way as L;
Nₕ is the number of times the tested self-driving vehicle system operates the vehicle, it is stipulated that when the absolute value of braking or acceleration is greater than 0.5 m/s², the brake pedal or accelerator pedal returns to the initial position as a vehicle operation, and when the steering wheel angle of the vehicle is greater than 10 degrees, it returns to the initial position from the reverse direction as a vehicle operation;
n_{A} is the average operation times of real drivers, and the operation times of a single real driver are obtained in the same way as nₕ; r is the road sampling position, defining the length along the road between each sampling is 0.5 m, and the sampling position is a line segment, that is, a line segment with the boundary of the lane in the coordinate system when x=r; when the distance between the penultimate sampling position and the road end point is less than 0.5 m, the road end point position of the segment is directly sampled without considering the interval of 0.5 m;
Pt_r is the Gaussian distribution formed by the vehicle position of the real driver on the sampling line segment, and the probability of the value of the vehicle position of the tested self-driving vehicle system in this Gaussian distribution, the description of the probability distribution of the real driver belonging to different Y values at the sampling position is shown in formula (6);
wherein h becomes the value of the vehicle position of different real drivers on the Y axis at the sampling position; μ and σ become the mean and standard deviation of the corresponding Y value; P_{t_2σ_r} is the probability that the vehicle position belongs to the mean of the true driver's Y axis position plus twice the standard deviation; P_{v_j} is the probability that the running locus field at different sampling points on the sampling line segment is the specific value when the real driver is driving, and is calculated using formula (6);
P_{v_2σ_j} is the driving trajectory of the real driver at different sampling points on the sampling line, which is the corresponding probability at the position of the average value at the sampling point plus twice the standard deviation at the sampling point;
nₛ is the number of sampling points on a sampling line segment, with a specific value of 9; nₘ is the number of all sampling points; k₃ and k₄ are correction coefficients, when the measured self-driving vehicle system operation times are less than the real driver and the driving range is longer than the real driver, the maximum value of D is corrected to 1 by using k₃ and k₄, and modify the results of other tested self-driving vehicle systems that have participated in the test evaluation, otherwise k₃, k₄ are 1;
sampling the road data forwarded with an interval of 0.5 m in the road direction until the end of the road;
when selecting a sampling point in a sampling line segment, take the vehicle position as the center, sample 4 points up and down at a step of 0.5 m, and sample 9 points in the whole slice. When the distance between the vehicle position and the road boundary on a sampling line segment is less than 2 m, divide the length between the vehicle position and the road boundary into four equal parts, and sample data at these four equal parts, regardless of the interval of 0.5 m;
according to the sampled data, the similarity between the tested self-driving vehicle system and the real driver is calculated by the formula (7) and the human-like evaluation result is obtained;
under real natural driving conditions, the higher the probability of occurrence of a scenario, the longer the driver experiences the scenario and the greater the proportion of the scenario; after obtaining the human-like evaluation index of a single specific scenario, the evaluation result within the whole safety area is obtained with the weight of probability, as shown in formula (8),
$$D = {\sum }_{i = 1}^{n} \frac{{p}_{i} \cdot {D}_{i}}{{\sum }_{i = 1}^{n} {p}_{i}} \qquad ( 8 )$$
in the formula (8), pᵢ is the probability of occurrence of the ith specific scenario in this type of scenario under natural driving conditions.

6. The method of claim 1, wherein the S5 further comprises:
in the evaluation of collision avoidance performance in a dangerous region, two parts are included, one part is whether the danger can be avoided, the other part is whether the collision loss can be reduced when the danger is unavoidable;
$${L}_{i} = \{ \begin{matrix}1 , & 15 < {U}_{i} \\ 0.7 , & 8 < {U}_{i} \leq 15 \\ 0.4 , & 0 < {U}_{i} \leq 8 \\ 0.1 , & others\end{matrix} \qquad ( 9 )$$
$${U}_{i} = \frac{1}{w} \cdot ‖ {v}_{e} - {v}_{o} ‖ \qquad ( 10 )$$
wherein Li is the collision loss of the measured method in the ith specific scenario; w is the bumper utilization rate of the measured vehicle during collision, that is, the area of the bumper involved in the collision, and the minimum is 0.5; vₑ and vₒ are the speed of the vehicle under test and the speed of the obstacle under test; U_i is the severity of the collision;
in addition to the collision loss, the importance weights of scenarios in different positions are also different; as for the collision, once it happens, it is a definite event for the passengers, so the avoidance ability of the collision should be considered in the danger zone, rather than the relative probability of the relevant scenario;
when evaluating the collision avoidance ability, consider the relative distance between the current specific scenario parameter position and the most dangerous parameter position, and the calculation method of the distance is shown in formula (11):
$${r}_{i} = \frac{‖ {r}_{i}^{*} ‖}{‖ {r}_{i}^{**} ‖} \qquad ( 11 )$$
wherein, is the relative weight of the ith specific scenario in the danger zone; rᵢ* is the vector formed by the most dangerous parameter points in the logical scenario parameter space and the specific scenario parameter points; rᵢ** is the vector formed by the intersection of the most dangerous parameter point in the parameter space of the logical scenario and the straight line where rᵢ* is located and the boundary of the safe region/dangerous region;
after the collision loss and the corresponding weight of the measured method in the specific scenario are obtained, the evaluation index of the whole danger zone is obtained; because the ideal algorithm assumes that its perception system, decision-making system and execution system are all running in an ideal state, its collision loss must be the smallest, so the value of c must be less than or equal to 1;
$$C = \frac{{\sum }_{i = 1}^{{n}_{c}} {r}_{i} \frac{{L}_{gi}}{{L}_{i}}}{{\sum }_{i = 1}^{{n}_{c}} {r}_{i}} , \qquad ( 12 )$$
in the formula, C is the safety index, L_{gi} is the collision loss of the ideal system in the ith specific scenario in the dangerous region, and n_{c} is the number of specific scenarios where all collisions occur.

7. The method of claim 1, wherein the S6 further comprises:
after obtaining the evaluation index in the safe region and the evaluation index in the dangerous region, the performance evaluation of the measured method in the whole logic scenario parameter space is obtained by combining them; based on the percentage system, the comprehensive evaluation index result of the measured method is as follows:
S=a·k₅·C+b·k₆·D (18)
wherein, a and b are the relative scores of safety index and smoothness index, and the sum of them is 100 in the case of 100-point system;
k₅ and k₆ are correction parameters when the number of systems under test is below a threshold, The threshold value is 10, and the two values can be 1 respectively, when the system under test exceeds the threshold value, the values of the two values are modified according to the statistical results, so that the evaluation results of different test systems have the statistical characteristics of Gaussian distribution or exponential distribution.
